(19) United States
(12) Patent Application Publication
(10) Pub. No.: US 2024/0338295 A1
(43) Pub. Date: Oct. 10, 2024

(54) TECHNIQUES INCLUDING INTERFACE CALL FLOW DETECTION AND CONTEXTUAL ENRICHMENT

(71) Applicant: Noname Gate Ltd., Tel Aviv-Yafo (IL)

(72) Inventors: Tomer ROIZMAN, Tel Aviv (IL); Adi VARDI, Tel Aviv (IL); Shai MEIR, Tzur Yitzhak (IL); Rami KREL, Tiberias (IL); Idan AHARONI, Tel Aviv (IL); Yuval ALKALAI TAVORI, Ramat Gan (IL); Idan TAGER, Givatayim (IL); Rami AZARIA, Jerualem (IL)

(73) Assignee: Noname Gate Ltd., Tel Aviv-Yafo (IL)

(21) Appl. No.: 18/297,797

(22) Filed: Apr. 10, 2023

(51) Int. Cl. G06F 11/36; G06F 21/52

(52) U.S. Cl. CPC G06F 11/3636; G06F 21/52

(57) ABSTRACT

A system and method for securing computing interfaces based on call flows. A method includes identifying a plurality of computing interface calls, wherein each computing interface call is identified as being associated with a user of a plurality of users; identifying at least one computing interface call flow with respect to the plurality of computing interface calls based on the user with which each computing interface call is associated, wherein each computing interface call flow includes an ordered sequence of computing interface calls among the plurality of computing interface calls; and detecting, based on the at least one computing interface call flow, at least one abnormality with respect to the plurality of computing interface calls.

### TECHNICAL FIELD

The present disclosure relates generally to computing interface cybersecurity, and more specifically to cybersecurity related to call flows for computing interfaces.

### BACKGROUND

The vast majority of cybersecurity breaches can be traced back to an issue with a computer interface such as an application programming interface (API). API abuses are expected to become the most frequent attack vector in the future, and insecure APIs have been identified as a significant threat to cloud computing.

An API is a computing interface. A computing interface is a shared boundary across which two or more separate components of a computer system exchange information. Computing interfaces therefore allow disparate computing components to effectively communicate with each other despite potential differences in communication format, content, and the like. An API defines interactions between software components.

A call to an API typically includes some form of method verb representing an action to be taken via an API (e.g., GET, POST, PUT, DELETE, etc.), a domain, and a path. Certain portions of API calls may be divided into segments, each of which might include parameters defining paths (or portions thereof), query parameters, or a combination of path parameters and query parameters.

Segments are typically defined with respect to one or more bookend characters such as, but not limited to, a pair of slash marks (with one slash mark at the beginning of the segment and another slash mark at the end), a beginning slash mark with no further segments thereafter (i.e., even without an ending slash mark), or an end slash mark without a slash mark preceding it. Each bookend character marks either the beginning or end of a segment such that the bookend characters can be used collectively to define different segments within an API.

As software infrastructure becomes more complex, communications involving multiple APIs also become more complex. For example, when logging into a service, APIs may be responsible for handling communications related to different parts of the service such as a login API, an authentication API, and a dashboard API.

Attackers attempting to exploit vulnerabilities in APIs may attempt to bypass certain APIs. For example, if an attacker is able to bypass the authentication API mentioned above, they can gain improper access to user data. Techniques which allow for preventing bypassing of APIs or otherwise improperly accessing data by manipulating communications between APIs would therefore be desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for securing computing interfaces based on call flows. The method comprises: identifying a plurality of computing interface calls, wherein each computing interface call is identified as being associated with a user of a plurality of users; identifying at least one computing interface call flow with respect to the plurality of computing interface calls based on the user with which each computing interface call is associated, wherein each computing interface call flow includes an ordered sequence of computing interface calls among the plurality of computing interface calls; and detecting, based on the at least one computing interface call flow, at least one abnormality with respect to the plurality of computing interface calls.

Certain embodiments disclosed herein also include a non-transitory computer readable medium having stored thereon causing a processing circuitry to execute a process, the process comprising: identifying a plurality of computing interface calls, wherein each computing interface call is identified as being associated with a user of a plurality of users; identifying at least one computing interface call flow with respect to the plurality of computing interface calls based on the user with which each computing interface call is associated, wherein each computing interface call flow includes an ordered sequence of computing interface calls among the plurality of computing interface calls; and detecting, based on the at least one computing interface call flow, at least one abnormality with respect to the plurality of computing interface calls.

Certain embodiments disclosed herein also include a system for securing computing interfaces based on call flows. The system comprises: a processing circuitry; and a memory, the memory containing instructions that, when executed by the processing circuitry, configure the system to: identify a plurality of computing interface calls, wherein each computing interface call is identified as being associated with a user of a plurality of users; identify at least one computing interface call flow with respect to the plurality of computing interface calls based on the user with which each computing interface call is associated, wherein each computing interface call flow includes an ordered sequence of computing interface calls among the plurality of computing interface calls; and detect, based on the at least one computing interface call flow, at least one abnormality with respect to the plurality of computing interface calls.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for securing computing interfaces with respect to call flows according to an embodiment.

FIG. 3 is a flowchart illustrating a method for identifying computing interface call flows with respect to users according to an embodiment.

FIG. 4 is a flowchart illustrating a method for filtering edges according to an embodiment.

FIG. 5 is an illustration of potential computing interface call flows utilized to describe various disclosed embodiments.

FIG. 6 is a schematic diagram of a call flow analyzer according to an embodiment.

FIG. 7 is a flowchart illustrating a method for clustering computing interface calls according to an embodiment.

### DETAILED DESCRIPTION

The various disclosed embodiments include techniques for identifying call flows for computing interfaces such as application programming interfaces (APIs) as well as techniques for using identified call flows in order to secure computing environments using such computing interfaces. In an embodiment, computing interface call flows are identified with respect to a type of each computing interface and a user identifier (ID) indicated in computing interface calls. In other words, call flows are defined with respect to types of computing interfaces being called by a given user, for example, either directly by a system or program operated by the user or indirectly as a result of a call from a computing interface which was triggered based on some action originating with the user. In a further embodiment, the computing interface call flows may be defined further with respect to sessions. In this regard, the process for identifying the computing interface call flows may distinguish between flows in different sessions for the same user.

As a non-limiting example used to illustrate computing interface call flows, a flow beginning with a call to a first API “A” by a user may ultimately result in a last call (e.g., last in time) during a given session for that user to an API “E.” Looking at the call flow naively based solely on the timings of API calls during the session may result in determining the following as the call flow for that session:

APIA→API B→APIC→APID→APIE Example1

In non-limiting Example 1, the APIs A through E are called in the order shown above with respect to time (i.e., API A is called before API B, API B is called before API C, etc.). However, when accounting for the actual flow between APIs (i.e., considering which APIs called each other), the real flow may actually include two parallel flows beginning with calling API A:

APIA→API B→APIC Example2

APIA→APID→APIE Example3

As shown in the non-limiting Examples 2 and 3, the call flows among APIs A through E actually include two distinct flows, each beginning with the calling of API A. If the baseline behavior of API call flows was established based on the flow shown in Example 1, a call from API A to API D (e.g., as shown in Example 3) may be detected as abnormal even though such a call is normal, and a call from API C to API D may not be detected as abnormal even though the call is unusual. The disclosed embodiments provide techniques which allow for more accurately modeling computing interface call flows and, consequently, which can be utilized to improve behavioral analysis with respect to such call flows used for cybersecurity.

Moreover, the disclosed embodiments include various techniques for filtering computing interface calls and graphing computing interface flows which may be utilized in order to improve call flow detection and utilization. In this regard, it has been identified that computing interface call data often includes calls which may occur around the same time as a broader call flow but which might not actually be part of that call flow such that those calls should not be considered part of that call flow for purposes of detecting abnormalities. The filtering may be utilized in order to remove calls which likely are not part of a broader trend with respect to multiple calls, thereby improving the accuracy of call flow detection and utilization.

In this regard, it has been identified that the calls between computing interfaces often follow certain patterns which can be defined with respect to the flow of calls from one computing interface to the next over a sequence of such calls. It has further been identified that these patterns tend to repeat when observed for specific users or sessions, i.e., when a call flow occurs during a session for a particular user, that same pattern may be repeated in other sessions, for other users, or both. Deviations from these known flows may therefore be utilized to detect cyber threats such as, but not limited to, attempts to bypass computing interfaces in attempts to gain unauthorized access. Each session is a time-delimited communication between systems or portions thereof with a starting point in time and an ending point in time.

A session for a user is a session involving communications between a system (or portion thereof) of the user and another system or portion thereof. Data transmitted during such a session may include user-identifying data identifying the user of the session. At least one of the systems or portions thereof involved in a session may store state-based data indicating a current state about the session, session history, or both. Identifying connections between computing interfaces (e.g., by graphing) with respect to sessions allows for improving call flow identification, as potential call flows are more likely to be represented within a given session as compared to a broader data set which is not session-specific. Thus, identifying such connections with respect to sessions may further improve the accuracy of call flow identification on top of the improvements provided by identifying such connections with respect to users.

As a non-limiting example, when accessing a service including potentially sensitive information for a user, APIs may be called in the following order: login API, then authentication API, then dashboard API. Calling of the next API in the sequence may be dependent upon the user completing a required action (e.g., providing a username and password for a login step using the login API, or providing multi-factor authentication information for an authentication step using the authentication API). An attacker attempting to gain unauthorized access to data or permissions available via a user's dashboard may attempt to bypass the authentication API such that they can gain access with only a username and password, and without other authentication credentials such as a password provided via a physical device that is not in the attacker's possession. The disclosed embodiments provide various solutions related to identifying patterns in call flow behavior which may be utilized to secure computing environments in which computing interfaces are deployed.

It has also been identified that effectively understanding call flow behavior for purposes such as cybersecurity may require identifying users indicated in computing interface calls in order to determine which computing interface calls are part of the same flow from a starting point to an endpoint. Some existing solutions for identifying users might utilize information such as Internet Protocol (IP) addresses, but this information does not always accurately identify specific users (e.g., when multiple users are at the same location and therefore share an IP address).

To this end, various disclosed embodiments provide techniques for identifying user identifiers for computing interface calls which may be utilized to determine and analyze computing interface call flows as described herein. Accordingly, such embodiments allow for improving accuracy of call flow determination as well as for improving cybersecurity of one or more computing environments using mitigation actions performed based on computing interface call flow behavior.

To support the call flow analyses discussed herein, certain disclosed embodiments further include techniques for clustering computing interface calls. Such clustering may be utilized to group computing interface calls which have, for example, different parameters, or otherwise whose contents vary slightly between instances despite including paths to the same endpoint. More specifically, clustering may be performed with respect to cluster definitions created using probabilistic modeling.

In this regard, it is noted that particular computing interface calls (e.g., computing interface calls having specific parameters) are not repeated for users often enough to derive meaningful insights regarding computing interface call behavior. Clustering different instances of computing interface calls based on paths allows for increasing the sample size of each group in a manner that allows for meaningfully representing behavior of computing interface calls with respect to certain endpoints. Additionally, such cluster definitions may be defined for entire computing interface names and therefore may be performed without requiring separating each incoming computing interface call into segments and processing the segments separately, which therefore reduces consumption of computing resources and allows for identifying applicable clusters more rapidly than hypothetical solutions requiring such segmentation.

Moreover, although solutions involving dictionaries could be utilized to identify parameters which may vary between computing interface calls to the same endpoint, only using predefined dictionary definitions of parameters would fail to recognize at least some parameters in circumstances such as, but not limited to, multiple parameters being concatenated within the same segment (e.g., “orderstatus” may not be recognized by a dictionary only having entries “order” and “status”), pluralized versions of words (e.g., “dogs” when the dictionary only includes the word “dog”), mixed data types (e.g., numbers mixed with letters such as “shop8787”), country codes or other minor variations, and the like.

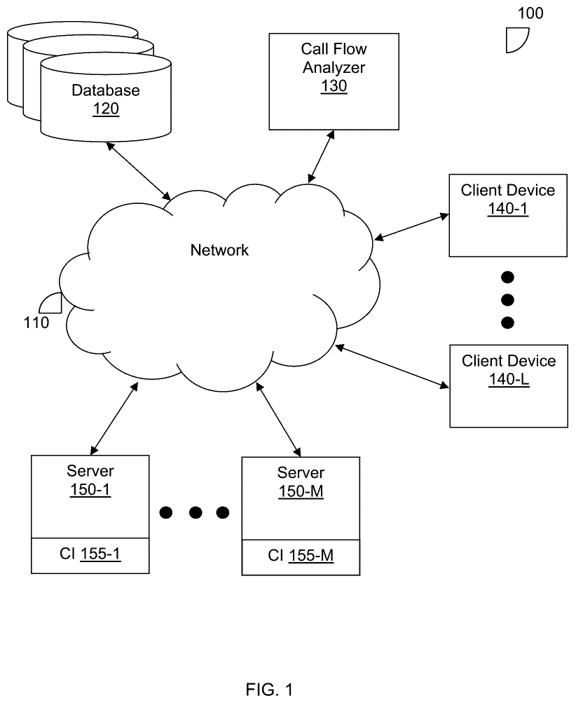

FIG. 1 shows an example network diagram 100 utilized to describe the various disclosed embodiments. In the example network diagram 100, one or more databases 120, a call flow analyzer 130, client devices 140-1 through 140-L (where L is an integer having a value equal to or greater than 1), and servers 150-1 through 150-M (where M is an integer having a value equal to or greater than 1) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The databases 120 store data related to existing computing interfaces such as, but not limited to, application programming interfaces (APIs). Such data may include, but is not limited to, computing interface names of specific instances of computing interfaces (e.g., as indicated in historical computing interface calls). The data may be utilized in order to define clusters with respect to computing interface names, which in turn may be utilized to cluster computing interface calls as described herein. The databases may further store computing interface calls made to the computing interfaces 155, which can be analyzed by the call flow analyzer 130 for behavioral anomalies as discussed herein.

The call flow analyzer 30 is configured to perform at least a portion of the disclosed embodiments related to clustering computing interface calls. To this end, the call flow analyzer 130 may be configured to define clusters (e.g., based on data obtained from the databases 120) and to utilize the cluster definitions to cluster computing interface calls (e.g., computing interface calls made by the client devices 140 to computing interfaces 155 of the servers 150, computing interface calls made between computing interfaces 155 among the servers 150, both, and the like).

Each of the client devices 140 may be, but is not limited to, a personal computer, a laptop, a tablet computer, a smartphone, a wearable computing device, or any other device configured to make computing interface calls to services hosted by the servers 150. The servers 150, in turn, host services used by the client devices 140, and utilize computing interfaces 155 in order to facilitate delivering those services. Computing interface calls made to the computing interfaces 155 among the servers 150 may be clustered as described herein and monitored in order to establish baseline behavior for each cluster in order to detect anomalous computing interface call behavior as described herein.

It should be noted that FIG. 1 depicts an “out-of-path” implementation in which the call flow analyzer 130 is deployed out of line, i.e., not as a middle system between servers among the servers 150. In certain implementations, the call flow analyzer 130 may be deployed inline between any or all of the servers 150, or multiple instances (not shown) of the call flow analyzer 130 may be deployed between servers among the servers 150, without limitation on the disclosed embodiments.

Further, the services hosted by the servers 150 may be “internal services” hosted on the servers 150, but the disclosed embodiments are equally applicable to implementations in which those internal services of the servers 150 may communicate with one or more “external services” hosted on servers other than the servers 150 (not shown). As a non-limiting example, the servers 150 may be servers operated by one entity in a first network environment, and the services hosted by the servers 150 may access services hosted by another entity in one or more other network environments.

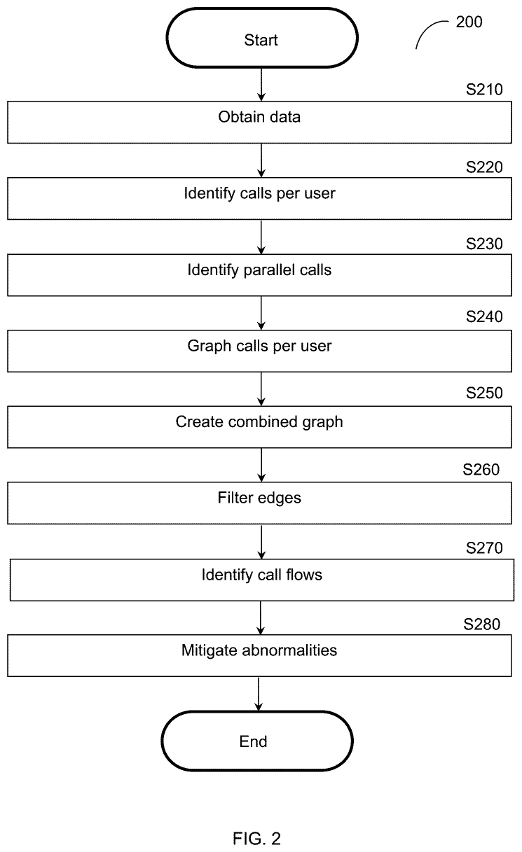

FIG. 2 is a flowchart 200 illustrating a method for securing computing interfaces with respect to call flows according to an embodiment. In an embodiment, the method is performed by the call flow analyzer 130, FIG. 1.

At S210, computing interface call data is obtained. The computing interface call data may include, but is not limited to, packets or other data related to transmissions between or within systems, at least some of which includes calls to computing interfaces such as Application Programming Interfaces (APIs). In some implementations, the data may be obtained by sampling from among traffic between and within systems using computing interfaces in order to, for example, facilitate delivery of services.

The computing interface call data may include data such as, but not limited to, computing interface identifiers, request time, response time, user identifier type, user identifiers, address (e.g., Internet Protocol address), parts of computing interface call (e.g., host, path, method, etc.), combinations thereof, and the like.

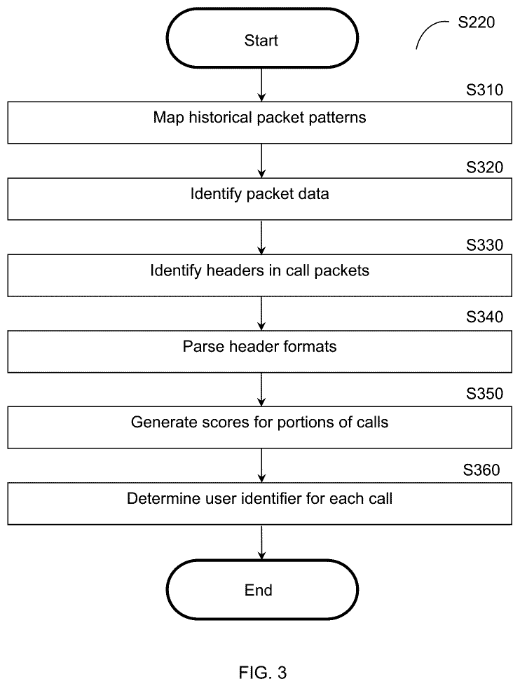

At S220, computing interface calls are identified with respect to users based on the computing interface call data. More specifically, S220 includes identifying a user identifier for each computing interface call based on traffic data (e.g., packets) of traffic by which computing interface calls were made such that each computing interface call is identified as being associated with or otherwise corresponding to a respective user. In other words, the user associated with each computing interface call is a user who initiated the computing interface call, either directly by a system or program operated by the user or indirectly as a result of a call from a computing interface which was triggered based on some action originating with the user. As discussed further below, identifying computing interface calls with respect to users allows for identifying potential call flows as sequences of calls associated with the same user, and can be analyzed across users to determine which potential call flows are actual call flows. An example process for identifying calls with respect to users is described further below with respect to FIG. 3.

In an embodiment, calls represented in the computing interface call data which have the same user identifier may be identified as being associated with the same user. As noted below, calls may be graphed per user. Calls associated with the same user based on user identifier may be graphed together in this manner.

In another embodiment, the computing interface calls are identified with respect to cluster definitions. Each cluster definition defines a general template for a computing interface call that allows for generalizing specific instances of computing interface calls which may vary with respect to parameters being passed via those computing interface calls. Such clustering is useful for identifying instances of effectively the same computing interface call across users because computing interface calls associated with different users typically include different parameters. Thus, classifying computing interface calls with respect to these generalized cluster definitions allows for identifying when the same endpoint is ultimately being called even across different users, which allows for identifying instances of the same computing interface call across users. Without clustering computing interface calls, at least some computing interface calls would likely be incorrectly classified as calls to distinct computing interfaces (and therefore parts of different call flows), thereby decreasing the accuracy of call flow identification and, consequently, reducing the ability to effectively secure computing environments affected by the computing interface call flows.

At S230, parallel calls are identified. The parallel calls are calls which at least partially overlap temporally. In an embodiment, S230 includes checking, for each call, whether that call is requested during the time between request and response of another call, i.e., if one call starts before another ongoing call ends. If a first call overlaps with a second call in that the first call is requested during the time between request and response of the second call, the overlapping first and second calls may be identified as parallel to each other. Any identifications of parallel calls may be utilized in order to graph connections between calls, for example, where parallel calls are not represented as part of the same chain or otherwise in the same call flow.

At S240, calls are graphed for each user in order to create user-specific call graphs, i.e., such that each graph represents calls made by a user either directly or indirectly (i.e., indirectly such that the call was made by a computing interface which was called either directly or indirectly by a system or program of the user). The user may be, but is not limited to, a user represented by one or more user identifiers among the computing interface call data. In a further embodiment, the calls are graphed with respect to sessions such that each graph represents calls made during a given session for a user. In yet a further embodiment, different graphs may further be created based on different types of user identifiers indicated in the computing interface call data.

In an embodiment, each graph is created based further on timing such that calls represented by edges in the graph are depicted in an order with respect to such timing. In a further embodiment, the calls are ordered based on request time. Each graph may therefore include nodes and edges, where each node represents a computing interface and each edge represents a call from one computing interface to another.

Further, by ordering the calls and connecting the calls based on which computing interface calls which other computing interface, the graph may effectively represent one or more chains of computing interfaces, each chain beginning with a starting computing interface and ending with a terminating computing interface. In some embodiments, chains including only one computing interface (i.e., where the starting and terminating computing interfaces are the same computing interface) may be ignored during subsequent processing.

The starting computing interface of each chain may be, for example, the first called computing interface chronologically (e.g., the computing interface which was indicated in the earliest call data among computing interface calls to be represented in the graph) of a particular user identifier of a particular type of user identifier which does not belong to any prior chains.

The terminating computing interface of each chain may be, for example, the last called computing interface chronologically (e.g., the computing interface which was indicated in the earliest call data among computing interface calls to be represented in the graph) of a particular user identifier of a particular type of user identifier, and may be identified when there are no other computing interface calls indicating the same user identifier type within a timeout period (i.e., a threshold period of time). As a non-limiting example, the timeout period may be a period of 10 minutes from the beginning of the chain, i.e., from the request time of the first computing interface represented in the chain. As another non-limiting example, the timeout period may be a dynamic time period which may change over time based on factors such as, but not limited to, data of the computing interface calls identified per user, organization (e.g., company), group (e.g., a business unit), and the like.

A non-limiting example set of data from which chains within a graph may be identified is depicted in Table 1:

TABLE 1

| Entry | API | Request | Response | Identifier | User |
|---|---|---|---|---|---|
| Number | ID | Time | Time | Type | Id |
| 1 | 1 | 07:41:00.937 | 07:41:00.962 | JWT | 111 |
| 2 | 2 | 07:41:04.747 | 07:41:04.843 | JWT | 111 |
| 3 | 3 | 07:42:12.003 | 07:42:12.043 | JWT | 111 |
| 4 | 4 | 07:55:12.003 | 07:55:12.043 | JWT | 111 |
| 5 | 1 | 07:55:13.013 | 07:55:13.053 | JWT | 111 |
| 6 | 6 | 06:41:00.937 | 06:41:00.962 | JWT | 112 |
| 7 | 7 | 06:42:00.937 | 06:42:00.962 | JWT | 112 |
| 8 | 8 | 04:41:00.937 | 04:41:00.962 | IP | 111 |
| 9 | 9 | 04:41:04.747 | 04:41:04.843 | IP | 111 |
| 10 | 10 | 04:42:12.003 | 04:42:12.043 | IP | 111 |

As depicted in Table 1, various computing interfaces being called are represented by API identifiers (IDs). As a non-limiting example, consider chains being defined with respect to a timeout period of 10 minutes since the earliest request time of each chain.

A first chain includes entry numbers 1-3, with entry number 3 representing the terminating computing interface of the first chain because entry number 3 is the last entry before a 10 minute timeout period has expired since the request time of the first computing interface represented in the chain (entry 1/API ID 1).

A second chain includes entry numbers 4 and 5. The call represented by entry number 5 is determined to be the call to the terminating computing interface because entry number 5 is the last entry before the user identifier changes from 111 to 112 (i.e., subsequent entries having user identifier 112 represent computing interface calls related to a different user).

A third chain includes entry numbers 6 and 7. The call represented by entry number 7 is determined to be the call to the terminating computing interface because entry number 7 is the last entry before the type of user identifier changes or, alternatively, because the user identifier changes from 112 to 111.

A fourth chain includes entry numbers 8-10. The call represented by entry number 10 is determined to be the call to the terminating computing interface because entry number 10 is the last entry when arranged in chronological order or, alternatively, the last entry in the chain before the timeout period of 10 minutes has expired.

At S250, a combined graph is created based on the user-specific call graphs. The combined graph includes all of the nodes and edges of the user-specific call graphs, and stores data indicating the number or relative number of instances of the call represented by each edge across all of the user-specific call graphs. In some implementations, the combined graph may exclude any self edges, i.e., edges representing a computing interface calling itself where the edge connects from a node to the same node.

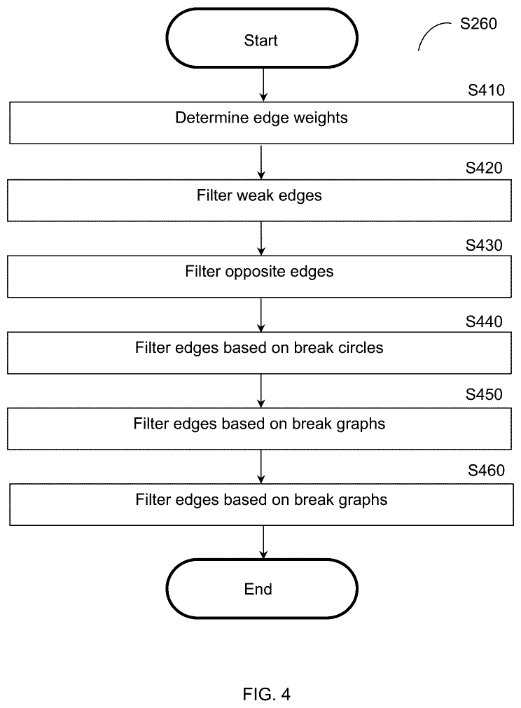

At optional S260, edges may be filtered from the combined graph. In some embodiments, weights are assigned based on numbers of instances of calls represented by different edges across users in the combined graph, and weak edges (e.g., edges representing calls with less than a threshold number or proportion of instances represented in the computing interface call data, or otherwise calls that are less represented in the computing interface call data) may be filtered. Various filters which may be applied are described further below with respect to FIG. 4.

At S270, call flows are identified within the combined graph. Each call flow may be identified as a chain beginning with a call to a starting computing interface and ending with a call to a terminating computing interface. The computing interface calls of each chain, organized in an ordered sequence of computing interface calls, may be identified as one of the call flows.

To this end, S270 may include applying one or more chain identification rules to the combined graph that define starting computing interfaces and terminating computing interfaces for chains, and identifying all computing interfaces called between the starting and terminating computing interfaces in a series. Further, the chain identification rules may include rules based on timing such as, but not limited to, rules for avoiding connecting parallel calls within chains, rules for ignoring periodic computing interface calls, both, and the like. The periodic computing interface calls are calls which have a high number of occurrences (e.g., a number of instances of the periodic call is above a threshold), which demonstrate low variance time difference (e.g., where the average time difference between requests for that computing interface is below a threshold), or both.

As noted above, the starting computing interface of each chain may be the earliest-called computing interface (e.g., the computing interface which was indicated in the earliest call data among computing interface calls to be represented in the graph) of a particular user identifier belonging to a particular type of user identifier which does not belong to any prior chains (e.g., was not called by any computing interfaces represented in any previously identified chains). Also noted above, the terminating computing interface of each chain may be the latest-called computing interface chronologically (e.g., the computing interface which was indicated in the earliest call data among computing interface calls to be represented in the graph) of a particular user identifier belonging to a particular type of user identifier, and may be identified when there are no other computing interface calls indicating the same user identifier or user identifier type within a timeout period (i.e., a threshold period of time).

At S280, one or more anomalous call flows may be mitigated. The anomalous call flows may be detected based on behavioral patterns (e.g., based on historical behavior), based on computing interface configurations (e.g., a call flow deviating from a required or otherwise intended call flow for a computing interface), both, and the like. In an embodiment, S290 may include performing one or more mitigation actions such as, but not limited to, blocking traffic to or from computing interfaces, blocking traffic to or from components using certain computing interfaces, reconfiguring computing interfaces (e.g., by changing a configuration that does not require authentication to a configuration that does require authentication or by placing a web application firewall configuration in front of an API server), lowering a rate limit number, generating a notification including a recommendation to reconfigure the component using the computing interface, combinations thereof, and the like.

In an embodiment in which at least some anomalous call flows are detected based on behavioral patterns, S290 may further include monitoring behavior of computing interface call flows over time in order to establish baseline behavior with respect to computing interface call flows. Such baseline behavior may be established based on call flows defined with respect to particular computing interfaces (e.g., API A calls API B, and API B proceeds to call API C), call flows defined with respect to types of computing interfaces (e.g., login API calls authentication API, and authentication API calls dashboard API). Call flows which deviate from baseline behavior (e.g., by having different API calls than would be expected) may be detected as anomalous call flows. Moreover, in some implementations, the amount by which a call flow deviates from the baseline behavior may be scored, and it may be checked whether the deviation score is above a threshold in order to determine whether the call flow is anomalous.

In an embodiment in which at least some anomalous call flows are detected based on computing interface configurations, one or more of the call flows may demonstrate a deviation from a required configuration such that the computing interface is determined to be misconfigured. To this end, in such an embodiment, S290 may include applying one or more misconfiguration detection rules. Moreover, the misconfiguration detection rules may be contextual misconfiguration detection rules defined with respect to combinations of configuration parameters of computing interfaces and traffic behaviors (i.e., behaviors reflected in one or more call flows involving a computing interface). Non-limiting examples for such contextual misconfiguration detection which may be utilized in combination with computing interface call flows are described further in U.S. patent application Ser. No. 17/645,165, assigned to the common assignee, the contents of which are hereby incorporated by reference.

FIG. 3 is a flowchart S220 illustrating a method for identifying computing interface call flows with respect to users according to an embodiment. The method of FIG. 3 may be utilized in order to find an appropriate and sufficiently specific identifier for each packet which may be utilized to identify a type of computing interface being called as represented in that packet. In accordance with various disclosed embodiments, the packet data is analyzed in order to determine a user identifier for each computing interface call.

At S310, historical packet patterns are mapped with respect to known packet techniques (e.g., patterns in formatting, content, and the like, of historical packets). In an embodiment, S310 further includes creating a tree based on the patterns.

At S320, packet data for which call typing classification is to be performed is identified.

The packet data may be included among computing interface call data, for example, the computing interface call data obtained at S210, FIG. 2.

At S330, headers are identified in packets. The headers may be identified based on the placement of data within the packets, the formatting of the packets, both, and the like.

At S340, potentially user-identifying data is extracted from the packets. In an embodiment, S340 includes at least analyzing data contained within a header of each packet, and may further include analyzing at least one other portion of each packet.

Non-limiting example header formats for headers of authentication computing interface calls include JavaScript Object Notation (JSON) Web Token (JWT), basic auth, Amazon Web Services (AWS), and the like. In an embodiment, S340 may include applying header parsing rules defined with respect to one or more known header formats, and may further include determining a header format of each header by analyzing the headers using header format identification rules. The header parsing rules may define, for example, relative locations of user-identifying data within headers formatted according to different header formats.

Moreover, each packet may be analyzed to identify other potentially user-identifying portions. As a non-limiting example, each packet may be analyzed to identify one or more cookies, with cookies being a common method of authentication and may therefore include user-identifying information. Thus, a portion of a packet including a cookie may be identified as a potentially user-identifying portion.

At S350, scores are generated for the potentially user-identifying portions of calls among the packets. In an embodiment, S350 includes applying one or more score generation rules defined based on a known, predetermined degree to which different portions of calls are likely to contain user-identifying information. As a non-limiting example, the score generation rules may include rules assigning higher scores to portions of packets such as portions including authentication headers (i.e., headers which typically identify a relevant token or authentication mechanism used to authenticate a user to a server), cookies (a common authentication method), combinations thereof, and the like.

At S360, a user identifier is determined for each call based on the generated scores. In an embodiment, a portion of the packet having the highest score may be determined as the user identifier of the packet. Determining user identifiers within packets in this manner may allow for consistently determining the user involved in a computing interface call represented in the packet even when the packet itself does not explicitly identify the portion containing the user identifier or where a format of the packet is unknown.

FIG. 4 is a flowchart S260 illustrating a method for filtering edges according to an embodiment.

At S410, weights are determined for edges in a graph (e.g., the combined graph created at S250, FIG. 2). In an embodiment, a weight is determined for each edge between any given pair of nodes based on a number of instances of calls between that pair of nodes for the edge. In a further embodiment, when there are multiple edges between a pair of nodes (e.g., one edge representing a call from a first computing interface of the pair of nodes to a second computing interface of the pair of nodes and another edge representing a call from the second computing interface to the first computing interface), a weight may be determined for each edge.

At S420, weak edges are filtered. The weak edges may be, but are not limited to, edges having a weight below a threshold. These weak edges are not represented in many instances among the data and, therefore, are less likely representative of true call flows.

At S430, at least some opposite edges are filtered. Each opposite edge is an edge between the same pair of nodes (e.g., nodes representing computing interfaces) as another edge but representing a call in the opposite direction (i.e., a first edge depicts a call from a first computing interface to a second computing interface, and a second edge that is an opposite edge for the first edge depicts a call from the second computing interface to the first computing interface.

As a non-limiting example, multiple edges between any two computing interfaces represented as nodes in a graph may represent calls from a first computing interface to a second computing interface as well as a call from the second computing interface to the first. As a non-limiting example, the following calls may be included in call flow data:

APIA→API B Example4

API B→APIA Example5

In accordance with at least some disclosed embodiments, the number of calls fitting each of Examples 4 and 5 may be compared in order to determine which call is weaker (e.g., which call has a lower number of instances represented in the data). Weaker calls between these kinds of opposite calls may be filtered and ignored for purposes of detecting call flows in order to improve the accuracy of call flow detection, as the weaker call among a pair of opposite calls is typically not representative of the broader flow even if the weaker call is not abnormal by itself (i.e., outside the context of a broader flow). As a non-limiting example, the call shown in Example 4 may have 1,000 calls in call flow data across multiple users, while the call shown in Example 5 has 1,000,000 calls in call flow data across multiple users such that an edge representing the call from API A to API B is filtered out from a graph and not utilized as part of a definition of a broader call flow.

At S440, edges are filtered with respect to break circles. In an embodiment, S440 includes identifying a circle, where the circle is a series of computing interface calls that result in looping to call the computing interfaces multiple times. As a non-limiting example, a flow like follows is a loop forming a circle:

APIA→API B→APIC→APID→APIA→API B→API C Example6

Once a circle has been identified, one or more break circle identification rules may be applied in order to determine which calls represented among the circle should be excluded. The determined calls may be excluded, thereby breaking the loop for purposes of establishing the graph. In an embodiment, calls to be excluded may include calls for which a number of instances of the call among the computing interface call data is below an edge factor, which is a threshold number of instances. As a non-limiting example, an edge factor may be 5 such that each pair of calls is checked beginning with the call A [symbol] B until a call having a number of instances less than 5 is identified. The edge representing that call, as well as edges representing any calls coming after that call before the circle repeats, may be excluded from subsequent processing.

At S450, edges are filtered with respect to break graphs. In an embodiment, S450 includes identifying nodes with large degrees (e.g., above a threshold), where the degree of a node is the number of edges which are incident upon the node and an edge is incident upon a node if the edge connects the node to another node. In a further embodiment, edges which are incident to a large degree node are filtered.

It should be noted that FIG. 4 is described with respect to filtering edges of a graph, but that at least some disclosed embodiments are equally applicable to filtering calls from call flows regardless of whether those calls are represented as edges in a graph without departing from the scope of the disclosure. It should be noted that the particular order of filtering depicted in FIG. 4 is shown merely for example purposes, and that any of the filtering steps described with respect to FIG. 4 may be performed in a different order or in parallel with any or all of the other filtering steps without departing from the scope of at least some disclosed embodiments. Additionally, some of the filtering steps may not be utilized in accordance with at least some disclosed embodiments, and other filtering steps aside from the steps depicted in FIG. 4 may be utilized in accordance with at least some disclosed embodiments.

It should also be noted that the filtering shown in FIG. 4 demonstrates a particular way of presenting a summarized or otherwise reduced set of information in the graph, which might allow for presenting the graph visually to a user (e.g., via a graphical user interface) in a manner that is user-friendly. However, at least some disclosed embodiments are not limited to the filtering as described with respect to FIG. 4, and other techniques from the field of graph theory may be utilized in addition to or instead of any of the steps of FIG. 4 without departing from at least some disclosed embodiments.

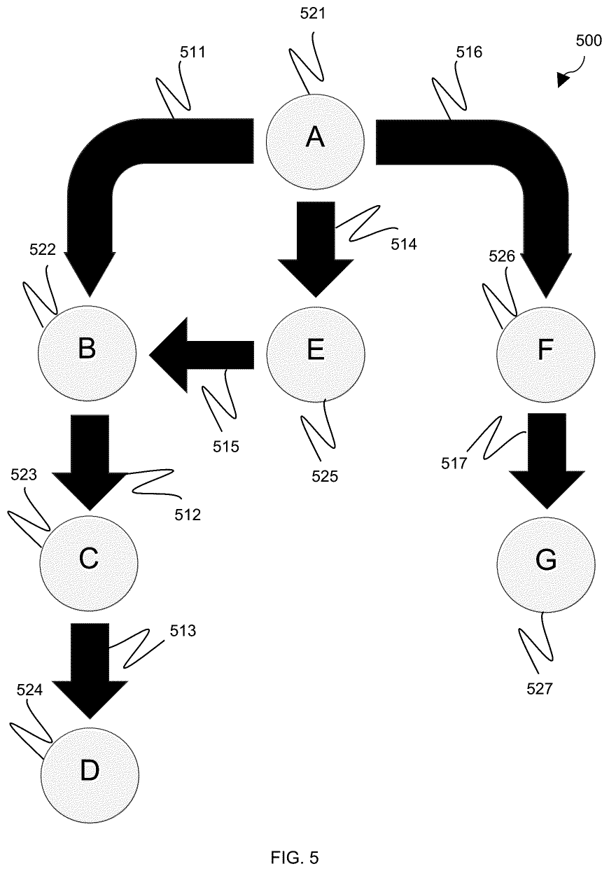

FIG. 5 is a non-limiting example illustration of a graph 500 of potential computing interface call flows utilized to describe various disclosed embodiments. The graph 500 depicts a series of edges 511 through 517 521 through 527. The illustration 500 depicts 3 potential call flows beginning with computing interface A 521:

APIA→API B→API C→APID

APIA→APIE→API B

APIA→API F→API G

The edges 511 through 517 represent respective calls between computing interfaces, and the nodes 521 through 527 represent the computing interfaces (depicted in FIG. 5. as computing interfaces A through G, respectively). In the graph 500, each of the edges 511 through 517 may be assigned a weight, where the weights are determined based on numbers of instances of their respective edges 511 through 517. The weights, in turn, may be used for purposes such as, but not limited to, filtering weak edges which are less likely to be representative of true call flows as discussed above.

Additionally, as discussed above, the graph 500 may be created by combining graphs created for different users. In this manner, the weights of the edges 511 through 517 may be determined based on the numbers of instances of the respective calls across different users. This allows for determining patterns with respect to call flows in a non-user specific manner even though the call flows themselves are user-specific. That is, as noted above, each call flow is identified based on data from a particular user (e.g., data for a particular session involving that user). However, certain call flows may only be observed once per user or per session, and as a result analysis of those call flows can be analyzed over multiple users in order to determine whether those call flows represent common patterns in computing interface call behavior.

As a non-limiting example, as noted above, the call flow API A→API E→API B represented in the graph 500 may have been observed as part of a broader call flow API A→APIE→API B→API H (API H not shown in FIG. 5) for one user. However, because the edge between API B and API H is observed only once among multiple users, that edge may have been filtered out and not considered to be a call flow for purposes of detecting abnormal call flow behavior.

As a non-limiting example, the graph 500 may include nodes and edges representing calls reflected in the following table:

TABLE 2

| API | Request | Response | Identifier | User |
|---|---|---|---|---|
| ID | Time | Time | Type | Id |
| 1 | 07:41:00.937 | 07:41:00.962 | JWT | 111 |
| 2 | 07:41:04.747 | 07:41:04.843 | JWT | 111 |
| 3 | 07:42:12.003 | 07:42:12.043 | JWT | 111 |
| 4 | 07:55:12.003 | 07:55:12.043 | JWT | 111 |
| 1 | 07:55:13.013 | 07:55:13.053 | JWT | 111 |
| 6 | 06:41:00.937 | 06:41:00.962 | JWT | 112 |
| 7 | 06:42:00.937 | 06:42:00.962 | JWT | 112 |

More specifically, the API identifiers 1, 2, 3, 4, 6, and 7 may correspond to nodes A 521, B 522, C 523, D 524, E 525, F 526, and G527, respectively. The graph 500 is therefore a combined graph including call flows involving user interface calls related to different users (i.e., the users corresponding to the user identifiers 111 and 112).

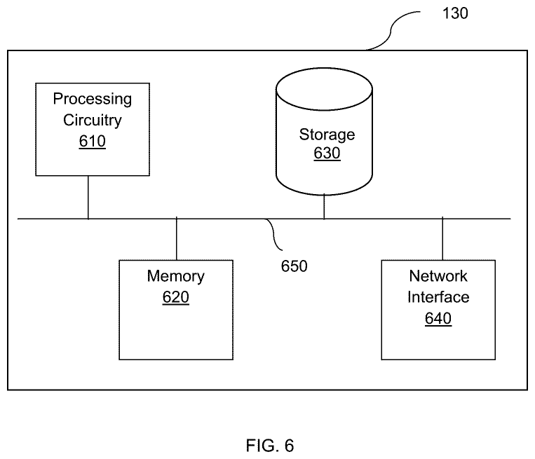

FIG. 6 is an example schematic diagram of a call flow analyzer 130 according to an embodiment. The call flow analyzer 130 includes a processing circuitry 610 coupled to a memory 620, a storage 630, and a network interface 640. In an embodiment, the components of the call flow analyzer 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the call flow analyzer 130 to communicate with, for example, the databases 120, the servers 150, and the like.

It should be understood that the embodiments described herein are not limited to the specific architecture illustrated in FIG. 6, and other architectures may be equally used without departing from the scope of the disclosed embodiments.

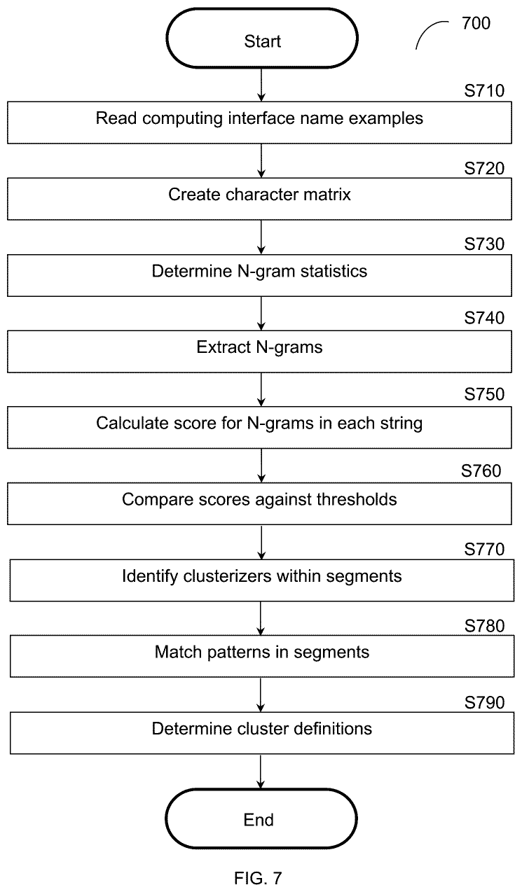

FIG. 7 is a flowchart 700 illustrating a method for defining computing interface clusters according to an embodiment.

At S710, computing interface name examples are read, for example, from a database (e.g., one or more of the databases 120, FIG. 1). In some implementations, the set of computing interface names examples are examples for a particular entity (e.g., an entity who owns or operates a computing environment hosting services to which computing interface calls are made). In this regard, cluster definitions may be created which are entity-specific in order to improve cluster determination when analyzing computing interface calls to or from computing interfaces for that entity.

At S720, a character matrix is created based on the computing interface name examples. The character matrix includes entries representing potential combinations of characters. In a non-limiting example implementation, a two-dimensional matrix is created including entries representing every combination of two English letters. Moreover, the character matrix may include each potential ordered combination of characters. As a non-limiting example, the ordered combinations “a-k” and “k-a” may be two entries in a two-dimensional character matrix.

It should be noted that S710 and S720 are depicted as part of a single flow with the rest of FIG. 7 merely for illustrative purposes, and that the disclosed embodiments are not necessarily limited to performing these steps as part of the same flow. As a non-limiting example according to at least some embodiments, character matrices may be created as discussed with respect to S710 and S720 in advance, and subsequently computing interface names may be analyzed with respect to these predefined character matrices. Further, the subsequently analyzed computing interface names may be names among the name examples, or may be a different set of names (e.g., a set of computing interface names belonging to a specific entity or organization). In this regard, the character matrix may be defined more generally (i.e., non-entity or organization specific), and the cluster definitions may be defined per entity or organization (i.e., based on the examples of general kinds of computing interface names observed within data related to that entity or organization).

At S730, N-gram statistics are determined for the computing interface name examples based on the character matrix. Each N-gram is a continuous sequence of N items, where N is an integer greater than or equal to 1. In an embodiment, each of the N-grams is a continuous sequence of 2 characters, where each sequence of 2 characters includes the characters of one of the potential combinations of characters represented in the character matrix.

In an embodiment, S730 includes calculating a number of occurrences (i.e., a count) of each N-gram. In a further embodiment, a value representing the relative frequency of each N-gram among the population of N-grams in the computing interface name examples is determined. In an example implementation, such a value may be calculated as log (count).

At S740, N-grams represented in the character matrix are extracted from the computing interface name examples. As a non-limiting example, when a string among the computing interface name examples is “Father”, the 2-grams “fa”, “at”, “th”, “he”, and “er” may be extracted from that string.

At S750, a score is determined for the N-grams in each string among the computing interface examples. As a non-limiting example for the “Father” example above, the score may be calculated as an average value as follows:

value(average)=[value(‘fa’)+value(‘at’)+value(′th)+value(′he)+value(‘er’)]/5

Where the value of each N-gram may be the value indicating relative frequency as discussed above with respect to S730.

At S760, it is determined whether each score is above a threshold. The threshold may be a predetermined threshold set based on the use case. As a non-limiting example, the threshold may be a predetermined value set for the English language (i.e., a known value used for determining meaningful English language words). In other words, such a comparison may allow for recognizing whether words are gibberish or otherwise lack meaning according to one or more languages.

In some implementations, the threshold is determined based on one or more datasets including labeled strings, where the labels indicate whether a given string in the datasets has a positive association as a “real” word or a negative association as a “gibberish” word. The positively labeled strings may be a dictionary of many example strings of known words, and the positively labeled strings may include random strings that collectively have the same or a similar distribution of lengths of those strings as compared to the dictionary of the positively labeled strings. The threshold may be selected so as to minimize mistakes, i.e., when the threshold is applied as discussed above, the threshold results in the lowest number of negatively labeled strings being above the threshold, the highest number of positively labeled strings being below the threshold, or both, as compared to other potential threshold values.

At S770, clusterizers are identified within segments of the computing interface examples based on the pattern matching. Each clusterizer is a string or substring which demonstrates a recurring pattern within the computing interface examples, for example, as determined using regular expressions.

In an embodiment, each segment among the computing interface name examples may be divided into clusterizers and leftovers, where the leftovers are portions of segments (e.g., strings) which do not belong to any clusterizer.

In a further embodiment, S770 may also include verifying one or more minimum count conditions for each potential clusterizer identified within segments. Such minimum count conditions may define minimum counts for each clusterizer with respect to counts of the clusterizers within segments, for example a number of instances of each clusterizer demonstrating the same ancestor (e.g., the same clusterizer preceding that clusterizer), a number of instances of each clusterizer appearing within the same segment pattern, both, and the like. Such minimum count conditions may serve as an additional check to ensure that clusterizers yield accurate clusters when utilized as part of cluster definitions.

Each segment pattern represents a pattern of the segment and may be defined with respect to clusterizers (or potential clusterizers) and leftovers within each segment such that each segment pattern represents the contents of the entire segment. Moreover, each segment pattern may be an ordered sequence of clusterizers and leftovers arranged according to the order in which each clusterizer or leftover appears within the segment. These segment patterns may be utilized to identify commonalities between segments, and moreover may be utilized as further evidence that a potential cluserizer is actually a clusterizer. That is, if a potential clusterizer appears in the same segment pattern above a threshold number of times, the potential clusterizer is much more likely to be an actual clusterizer. Each leftover may be generalized into a general format leftover based on the type of data, how the characters of the leftover are arranged, both, and the like.

At S780, clusterized string lists are matched between the segments of the computing interface examples. In an embodiment, S780 includes generating a clusterized string list for each segment, where the clusterized string list is an ordered list of clusterizers in each segment which can be compared in order to match between segments (i.e., two segments may match if the clusterized string lists of the segments match). The clusterized string lists may be utilized to determine cluster definitions, more specifically, by performing a multiple clusterizer test for segments including multiple clusterizers in addition to the per-clusterizer count tests discussed above.

At S790, cluster definitions are determined based on the pattern matching. In an embodiment, the cluster definitions are added to a cluster definitions dictionary which can be referenced in order to determine clusters to which computing interfaces indicated in subsequent computing interface calls belong. The cluster definitions may be provided to an engine for use in identifying clusters by comparing the cluster definitions to subsequent computing interface calls as discussed above.

In an embodiment, S790 further includes performing a multiple clusterizer test to determine whether the set of clusterizers included in each computing interface name example having multiple clusterizers is likely a cluster. To this end, in some embodiments, a cluster is created based on computing interface name examples for which all clusterizers identified therein satisfy the minimum count condition or conditions. When all clusterizers of a computing interface name example fail to satisfy the minimum count condition or conditions, the segments of that computing interface name example may be ignored and a cluster is not created based on those segments.

In a further embodiment, when some of the clusterizers in a computing interface name example meet the minimum count condition or conditions and others fail to satisfy those conditions, an additional check may be performed to determine whether to create a cluster based on that example. In yet a further embodiment, pairs of segment patterns and portions of clusterized string lists are created and utilized to replace clusterizers that failed to meet the applicable conditions. More specifically, each clusterizer that failed to meet those conditions may be replaced with a corresponding portion of the paired clusterized string list. The result is a replaced segment pattern, which may be added as a cluster definition to the cluster dictionary.

It should be noted that various embodiments are depicted or discussed with respect to APIs as a particular type of computing interface which may be called, but that the disclosed embodiments are not limited to APIs. Call flows between other types of computing interfaces, between APIs and other types of computing interfaces, or both, may be identified and analyzed as described herein without departing from the scope of the disclosure.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for securing computing interfaces based on call flows, comprising:
identifying a plurality of computing interface calls, wherein each computing interface call is identified as being associated with a user of a plurality of users;
identifying at least one computing interface call flow with respect to the plurality of computing interface calls based on the user with which each computing interface call is associated, wherein each computing interface call flow includes an ordered sequence of computing interface calls among the plurality of computing interface calls; and
detecting, based on the at least one computing interface call flow, at least one abnormality with respect to the plurality of computing interface calls.

2. The method of claim 1, further comprising:
securing at least one computing environment by performing at least one mitigation action to mitigate the detected at least one abnormality.

3. The method of claim 1, further comprising:
creating at least one graph, wherein each graph includes nodes and edges, wherein each node represents a respective computing interface of a plurality of computing interfaces, wherein each edge represents at least one of the plurality of computing interface calls, wherein the at least one computing interface call flow is identified based on the at least one graph.

4. The method of claim 3, wherein the at least one graph includes a plurality of first graphs and a second graph, further comprising:
creating the plurality of first graphs, wherein each first graph includes a plurality of computing interface calls corresponding to a respective user of the plurality of users; and
combining the plurality of first graphs to create the second graph, wherein the at least one call flow is identified based on the second graph.

5. The method of claim 4, wherein each of the plurality of first graphs is created for a respective session of a plurality of sessions.

6. The method of claim 4, further comprising:
filtering at least one edge from the second graph based on a number of instances of the computing interface call represented by each edge among the second graph.

7. The method of claim 6, wherein filtering the at least one edge from the second graph further comprises:
identifying at least one pair of opposite edges in the second graph, wherein each pair of opposite edges includes an edge representing a call from a first computing interface to a second computing interface and an edge representing a call from the second computing interface to the first computing interface, wherein the at least one edge filtered from the second graph includes any of the first edge and the second edge from each pair of opposite edges.

8. The method of claim 1, further comprising:
determining a user identifier for each of the plurality of computing interface calls by analyzing a plurality of packets of computing interface call data indicating the plurality of computing interface calls, wherein each user identifier corresponds to one of the plurality of users, wherein the plurality of computing interface call flows are identified based on the user identified determined for each of the plurality of computing interface calls.

9. The method of claim 8, wherein determining the user identifier for each of the plurality of computing interface calls further comprises:
extracting data from at least one portion of a first packet of the plurality of packets; and
generating a score for each portion of the first packet, wherein the score for each portion indicates a likelihood that the portion contains user-identifying information, wherein the user identifier for each of the plurality of computing interface calls is determined to be the data extracted from the portion of the first packet having the highest score.

10. The method of claim 1, further comprising:
identifying at least one pair of parallel computing interface calls, wherein each pair of parallel computing interface calls has two computing interface calls which overlap, wherein the at least one computing interface call flow is identified based further on the at least one pair of parallel computing interface calls.

11. A non-transitory computer readable medium having stored thereon instructions for causing a processing circuitry to execute a process, the process comprising:
identifying a plurality of computing interface calls, wherein each computing interface call is identified as being associated with a user of a plurality of users;
identifying at least one computing interface call flow with respect to the plurality of computing interface calls based on the user with which each computing interface call is associated, wherein each computing interface call flow includes an ordered sequence of computing interface calls among the plurality of computing interface calls; and
detecting, based on the at least one computing interface call flow, at least one abnormality with respect to the plurality of computing interface calls.

12. A system for securing computing interfaces based on call flows, comprising:
a processing circuitry; and
a memory, the memory containing instructions that, when executed by the processing circuitry, configure the system to:
identify a plurality of computing interface calls, wherein each computing interface call is identified as being associated with a user of a plurality of users;
identify at least one computing interface call flow with respect to the plurality of computing interface calls based on the user with which each computing interface call is associated, wherein each computing interface call flow includes an ordered sequence of computing interface calls among the plurality of computing interface calls; and
detect, based on the at least one computing interface call flow, at least one abnormality with respect to the plurality of computing interface calls.

13. The system of claim 12, wherein the system is further configured to:
secure at least one computing environment by performing at least one mitigation action to mitigate the detected at least one abnormality.

14. The system of claim 12, wherein the system is further configured to:
create at least one graph, wherein each graph includes nodes and edges, wherein each node represents a respective computing interface of a plurality of computing interfaces, wherein each edge represents at least one of the plurality of computing interface calls, wherein the at least one computing interface call flow is identified based on the at least one graph.

15. The system of claim 14, wherein the at least one graph includes a plurality of first graphs and a second graph, wherein the system is further configured to:
create the plurality of first graphs, wherein each first graph includes a plurality of computing interface calls corresponding to a respective user of the plurality of users; and
combine the plurality of first graphs to create the second graph, wherein the at least one call flow is identified based on the second graph.

16. The system of claim 15, wherein each of the plurality of first graphs is created for a respective session of a plurality of sessions.

17. The system of claim 15, wherein the system is further configured to:
filter at least one edge from the second graph based on a number of instances of the computing interface call represented by each edge among the second graph.

18. The system of claim 17, wherein the system is further configured to:
identify at least one pair of opposite edges in the second graph, wherein each pair of opposite edges includes an edge representing a call from a first computing interface to a second computing interface and an edge representing a call from the second computing interface to the first computing interface, wherein the at least one edge filtered from the second graph includes any of the first edge and the second edge from each pair of opposite edges.

19. The system of claim 12, wherein the system is further configured to:
determine a user identifier for each of the plurality of computing interface calls by analyzing a plurality of packets of computing interface call data indicating the plurality of computing interface calls, wherein each user identifier corresponds to one of the plurality of users, wherein the plurality of computing interface call flows are identified based on the user identified determined for each of the plurality of computing interface calls.

20. The system of claim 19, wherein the system is further configured to:
extract data from at least one portion of a first packet of the plurality of packets; and
generate a score for each portion of the first packet, wherein the score for each portion indicates a likelihood that the portion contains user-identifying information, wherein the user identifier for each of the plurality of computing interface calls is determined to be the data extracted from the portion of the first packet having the highest score.

21. The system of claim 12, wherein the system is further configured to:
identify at least one pair of parallel computing interface calls, wherein each pair of parallel computing interface calls has two computing interface calls which overlap, wherein the at least one computing interface call flow is identified based further on the at least one pair of parallel computing interface calls.
